(19) United States
(12) Patent Application Publication
(10) Pub. No.: US 2020/0159308 A1
(43) Pub. Date: May 21, 2020

(54) MOBILE TERMINAL, METHOD OF CONTROLLING DOZE MODE OF MOBILE TERMINAL, AND COMPUTER-READABLE NON-TRANSITORY STORAGE MEDIUM

(71) Applicant: HUIZHOU TCL MOBILE COMMUNICATION CO., LTD., Huizhou (CN)

(72) Inventors: Lanying He, Huizhou (CN); Yeqing Lv, Huizhou (CN); Qicai Gu, Huizhou (CN); Bin Song, Huizhou (CN); Rongxiao Deng, Huizhou (CN); Guangming Yang, Huizhou (CN)

(21) Appl. No.: 16/748,789

(22) Filed: Jan. 21, 2020

Related U.S. Application Data
(63) Continuation of application No. PCT/CN2018/096846, filed on Jul. 24, 2018.

(30) Foreign Application Priority Data
Jul. 31, 2017 (CN) 201710644550.0

(51) Int. Cl. G06F 1/3231; G06F 1/3296; G06F 3/01

(52) U.S. Cl. CPC G06F 1/3231; G06F 3/011; G06F 3/017; G06F 1/3296

(57) ABSTRACT

A mobile terminal, a method of controlling a Doze mode of a mobile terminal, and a computer-readable non-transitory storage medium may be provided. The method includes: detecting whether the mobile terminal is in the Doze mode; in response to the mobile terminal in the Doze mode, activating the accelerometer to sense a particular motion change; and in response to the particular motion change reaching a predefined threshold, deactivating the Doze mode.

### CROSS REFERENCE TO RELATED APPLICATIONS

The present application is a continuation-application of International (PCT) Patent Application No. PCT/CN2018/096846 filed on Jul. 24, 2018, which claims foreign priority of Chinese Patent Application No. 201710644550.0, filed on Jul. 31, 2017, in China National Intellectual Property Administration, the contents of all of which are hereby incorporated by reference.

### TECHNICAL HELD

The present disclosure relates to the field of computers, and in particularly to a mobile terminal, a method of controlling a Doze mode of the mobile terminal, and a computer-readable non-transitory storage medium.

### BACKGROUND

As an area of a display screen of a mobile terminal increases, and a calculating capacity of a processor increases, power consumption of the mobile terminal continually increases accordingly. Various manufactures have been focusing on how to reduce the power consumption to improve battery performance.

For Android M and any later version of the Android, Google has introduced a Doze mode to improve the battery performance. The Doze mode is a new and low-power consumption mode. In the Doze mode, a background of the mobile terminal may allow only some tasks to run, whereas other tasks are forced to stop running. When the user is not using the mobile terminal for a period of time, the Doze mode may suspend a central processing unit (CPU) at the background of an application and reduce network-based operations to reduce the power consumption. In the mobile terminal in the art, a primary condition for activating the Doze mode may be arranging a significant motion sensor in the mobile terminal. The significant motion sensor may sense a substantial movement of the mobile terminal. When the significant motion sensor senses the mobile terminal is having a substantial movement, the mobile terminal may be activated, and the Doze mode may be deactivated. However, the significant motion sensor may be expensive, and the mobile terminal in the art tends to be lighter and thinner, any additional components may cause inconvenience for manufacture, increasing the power consumption and manufacture cost.

Therefore, an improved control method of the Doze mode may be necessary.

### SUMMARY OF THE DISCLOSURE

The present disclosure provides a mobile terminal, a method of controlling a Doze mode of the mobile terminal, and a computer-readable non-transitory storage medium, using an accelerometer to achieve a function of the significant motion sensor.

The present disclosure provides a method of controlling a Doze mode of a mobile terminal, the method includes: detecting whether the mobile terminal is in the Doze mode; in response to the mobile terminal in the Doze mode, configuring a register to adjust amplitude and a range of a gravitational change required to be detected by an accelerometer, and initiating the accelerometer to sense a particular motion change; and in response to the particular motion change reaching a predefined threshold for a plurality of times consecutively within a predefined period of time, deactivating the Doze mode.

The present disclosure further provides a method of controlling a Doze mode of a mobile terminal, including following operations.

The mobile terminal may be detected whether in the Doze mode.

In response to the mobile terminal in the Doze mode, the accelerometer is initiated to sense a particular motion change.

In response to the particular motion change reaching a predefined threshold, the Doze mode is deactivated.

Alternatively, the particular motion change is a gravitational change, and the particular motion change may be calculated based on a potential function of the gravitational change.

Further, in response to the particular motion change reaching the predefined threshold, the mobile terminal deactivating the Doze mode includes: in response to the particular motion change reaching the predefined threshold for a plurality of times consecutively within a predefined period of time, deactivating the Doze mode by the mobile terminal.

Further, in response to the mobile terminal in the Doze mode, initiating the accelerometer to sense the particular motion change includes: in response to the mobile terminal in the Doze mode, configuring a register to adjust the amplitude and the range of the gravitational change required to be detected by the accelerometer, and initiating the accelerometer to sense the particular motion change.

Further, before the mobile terminal being detected whether in the Doze mode, the method further includes: initiating the accelerometer and subsequently loading an application for sensing the particular motion.

Further, after, in response to the particular motion change reaching the predefined threshold, the mobile terminal deactivating the Doze mode, the method further includes: the accelerometer receiving a control instruction of the mobile terminal and stopping sensing the particular motion change.

The mobile terminal includes a mobile phone, a tablet computer, and an intelligent watch.

The present disclosure further provides a mobile terminal, including a communication circuit, a non-transitory memory, and a processor.

The communication circuit is arranged to transmit a control instruction of the mobile terminal.

The non-transitory memory is arranged to store data generated during the mobile terminal running.

The processor is arranged to execute a computer program to perform following operations.

The processor may detect whether the mobile terminal is in the Doze mode.

In response to the mobile terminal in the Doze mode, the accelerometer may be initiated to sense a particular motion change.

In response to the particular motion change reaching a predefined threshold, the processor may deactivate the Doze mode.

The present disclosure may further provide a non-transitory storage medium. The medium stores a program able to be executed by a processor. The program is executed to perform following operations. The processor may detect whether a mobile terminal is in the Doze mode. In response to the mobile terminal in the Doze mode, the accelerometer is initiated to sense a particular motion change. In response to the particular motion change reaching a predefined threshold, the mobile terminal deactivates the Doze mode.

According to the present disclosure, the mobile terminal may configure the register to adjust the amplitude and the range of the particular motion change required to be detected by the accelerometer, such that the function of the significant motion sensor may be replaced. Without increasing manufacture cost, the power consumption may be reduced, and the battery performance may be improved effectively, improving user experience.

### BRIEF DESCRIPTION OF THE DRAWINGS

FIG. 1 is a flow chart of a method of controlling a Doze mode of a mobile terminal according to an embodiment of the present disclosure.

FIG. 2 is a flow chart of a MTK sensor structure driving an accelerometer according to an embodiment of the present disclosure.

FIG. 3 is a structural diagram of a mobile terminal according to an embodiment of the present disclosure.

FIG. 4 is a structural diagram of a computer-readable non-transitory storage medium according to an embodiment of the present disclosure.

### DETAILED DESCRIPTION

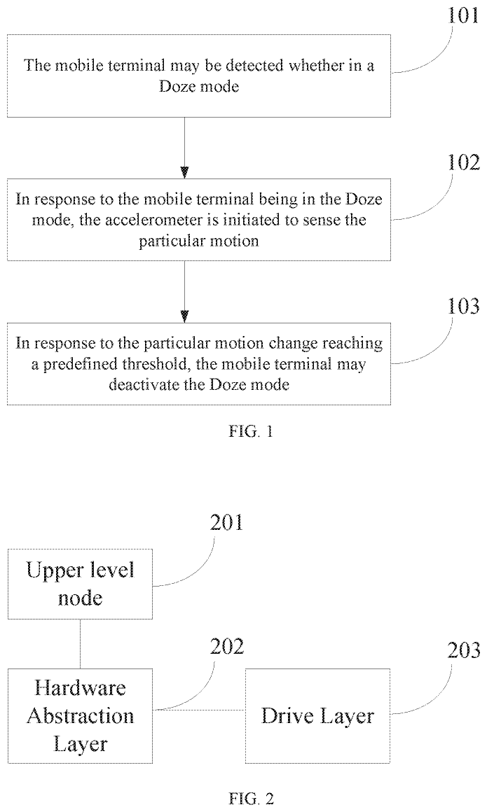

As shown in FIG. 1, a flow chart of a method of controlling a Doze mode of a mobile terminal is provided. The method includes following operations.

At block 101, the mobile terminal may detect whether the mobile terminal in the Doze mode.

The Doze mode is a new mode released in Android6.0, and is a new and low-power consumption mode. The Doze mode allows only some tasks to run at a background, other tasks may be forced to stop running. When a user is not using the mobile terminal for a period of time, in the Doze mode, a central processing unit (CPU) at the background of an application and network-based operations may be suspended to reduce the power consumption.

In a scenario, the mobile terminal may include a mobile phone, a tablet computer, and an intelligent watch, with proviso of the mobile terminal being arranged with an accelerometer and the Doze mode and a system of the mobile terminal having the Doze mode installed.

In an implementation, before the mobile terminal detects whether the mobile terminal is in the Doze mode, following operations may be performed. After the accelerometer is initiated, an application sensing a particular motion may be loaded. In such a way, in subsequent operations, the accelerometer may sense the particular motion by the loaded application.

At block 102, in response to the mobile terminal in the Doze mode, the accelerometer is initiated to sense the particular motion.

Further, in response to the mobile terminal in the Doze mode, initiating the accelerometer to sense the particular motion includes: in response to the mobile terminal in the Doze mode, configuring a register to adjust amplitude and a range of a gravitational change required to be detected by the accelerometer, and initiating the accelerometer to sense a particular motion change.

In an implementation, taking mobile phone as an example. Under a normal circumstance, the accelerometer detects acceleration of the mobile phone along three axes, including gravitational acceleration and motion acceleration. Usually, acceleration of the mobile phone at rest may be detected, and that is the gravitational acceleration. The acceleration may include magnitude and a direction, that is, the acceleration may be a vector. By detecting the vector, the mobile phone may be determined to be at rest or exhibiting uniform rectilinear motion, based on whether the acceleration is equal to 9.8 m/s², which is the value of the gravitational acceleration g. In response to the acceleration being equal to 9.8 m/s², the mobile phone may be determined to be at rest or exhibiting uniform rectilinear motion, and the direction of the acceleration may be detected to determine a pose of the mobile phone. This is also a principle of switching between a horizontal screen and a vertical screen. In other words, under a normal circumstance, the accelerometer continually outputs the acceleration along the three axes. A change of a fine movement of the mobile phone may be deducted based on a tiny change of data, such as an angle of the horizontal or vertical screen, an angle of inverting the mobile phone, or the like.

In the present embodiment, the accelerometer is required to sense the change of the fine movement and further sense a change of a significant movement (that is, the particular motion change). To meet a demand of accuracy and a measurement range, the register may be configured to adjust the amplitude and the range of the gravitational change required to be detected by the accelerator.

In the present embodiment, the particular motion change may be the gravitational change, calculated based on a potential function of the gravitational change. In other implementations, the particular motion change may be other types of motion changes and shall not be limited by the present disclosure.

At block 103, in response to the value of the particular motion change reaching a predefined threshold, the mobile terminal may deactivate the Doze mode.

Further, after the mobile terminal deactivates the Doze mode, the accelerometer may receive a control instruction from the mobile terminal and stop sensing the particular motion change.

In response to the particular motion change not reaching the predefined threshold, the accelerometer may continue sensing the particular motion change.

In an implementation, taking a mobile phone having the Android of a version later than Android M as an example, from Android 6.0, the Doze mode is provided to suspend the CPU at the background of an unused application and network-based operations to allow the unused application to remain in a Standby status to reduce the power consumption. At the same time, 1.5 g (1.5 times of the gravitational acceleration) may be set as the predefined threshold. After the user activates the Doze mode, the accelerometer may detect the gravitational acceleration of the mobile phone to be 1 g, and the mobile phone may remain in the Doze mode. When the user activates or operates the mobile phone by mistake, the accelerometer may detect that the gravitational acceleration of the mobile phone changes. At this time, the gravitational acceleration may be 1.2 g (less than the threshold 1.5 g). The mobile phone may determine that activation or an operation by mistake may be performed, and the Doze mode is still activated. When the user uses or operates the mobile phone for real, the accelerometer may detect the gravitational acceleration may be 1.6 g (greater than the threshold 1.5 g), the mobile phone may determine a typical activation or operation is performed, and the Doze mode may be deactivated. The accelerometer may receive the control instruction from the mobile phone to stop sensing the gravitational change.

In the present embodiment, the threshold is not a fixed value, and may be adjusted according to the user's demand, and shall not be limited herein.

In another implementation, the accelerometer may set various determination criteria according to the user's demand. For example, when the gravitational change exceeds the predefined threshold, the Doze mode may not be deactivated, but only in response to the gravitational change exceeding the predefined threshold for a plurality of times consecutively within a predefined period of time, the Doze mode may be deactivated. In such a way, deactivation of the Doze mode by mistake due to activating or operating the mobile phone by mistake may further be reduced. In the present implementation, the predefined period of time and the number of times may be set manually by the user. The Doze mode may further be deactivated by the user's manual operation.

According to the present disclosure, the mobile terminal may configure the register to adjust the amplitude and the range of the gravitational change required to be detected by the accelerometer to detect to replace the function of the significant motion sensor. Without increasing manufacture cost, the power consumption may be reduced, and the battery performance may be improved, improving user experience.

As shown in FIG. 2, a flow chart of a MTK sensor structure driving an accelerometer according to an embodiment of the present disclosure is provided. A structure of the MTK sensor includes an upper level node 201, a hardware abstraction layer 202, and a drive layer 203. The upper level node 201 may be arranged to monitor a variation detected by a sensor and provide a feedback based on the variation. The hardware abstraction layer 202 may be arranged to shield a low level drive layer difference and perform operations to the drive layer. The drive layer 203 may be arranged to initiate the sensor and read and write to the register based on a hardware design, such that the sensor may function normally. In the present embodiment, driving the accelerometer using the MTK sensor structure may replace the arrangement of the conventional significant motion sensor.

Driving the accelerometer using the MTK sensor structure may include following operations. The mobile terminal may invoke a particular function to acquire a MTK sensor module. The hardware abstraction layer 202 may invoke an operation interface of the mobile terminal based on information of the mobile terminal module to obtain a list of sensors, such that the accelerometer may register a standard application programming interface (API) of the particular motion change. The register related to the accelerometer may be configured, and an interruption function of the accelerometer may be activated. The register may be configured to adjust the amplitude and the range of the gravitational change required to be detected by the accelerometer.

To be specific, based on the control instruction, the upper level node 201 may send the control instruction to the drive layer 203 through the hardware abstraction layer 202. The drive layer 203 may obtain the control instruction and configure the register of the accelerometer and activate the interruption function. In response to the accelerometer of the mobile terminal detecting the gravitational change (i.e., the particular motion change) exceeding the predefined threshold, the system may be activated and the Doze mode may be deactivated, and the accelerometer may stop sensing the particular motion change.

The accelerometer registering the standard application programming interface of the particular motion change may include: activating the accelerometer of the mobile terminal, and accomplishing registration of the accelerometer through the hardware abstraction layer 202. In response to accomplishing the registration of the accelerometer, an application sensing the particular movement may be loaded immediately to accomplish registration of the particular motion change. The mobile terminal may activate the Doze mode based on an instruction of registration accomplished.

With the MTK sensor structure, the API defined by the Android provides various ways for the drive layer to find sensors arranged in the device easily. The API may further clarifies an information and function interface of each sensor, such as a name of the sensor, a type of the sensor, a manufacturer of the sensor, a range of data detected by the sensor, accuracy of the data detected by the sensor, and the like. In such a way, the sensor may be selected easily, and sensor information may be set easily. In a specific implementation, sensors in various types may be managed and compatible through the MTK platform. The accelerometer of the mobile terminal may determine current registration information, register information, and interface information based on the MTK platform. More specifically, based on the user's demand, various interfaces and registration information of the current accelerometer may be configured, such that the current accelerometer may provide feedback information through monitoring in a predefined particular movement state, the Doze mode may be automatically deactivated, and a control of the Doze mode may be achieved based on the user's setting. As a relatively mature driving technique through the MTK sensor structure has already been established, configuring related accelerometer and defining registration of the particular motion change may only be required to replace the significant motion sensor in the Doze mode to accomplish the control of the Doze mode of the mobile terminal.

According to the present embodiment, driving the accelerometer by the MTK sensor structure may replace a conventional significant motion sensor. In the above-mentioned method, based on a current mobile terminal, an interface mode of the accelerometer may be changed to quickly replace the significant motion sensor and achieve adjustment of a direction of a sensor. Without increasing manufacturing cost, the power consumption may be reduced, and the battery performance may be improved effectively, improving user experience.

Further, according to the present implementation, the mobile terminal may generate the control instruction based on a current running state; the mobile terminal may activate a sleep mode based on the control instruction and trigger the upper level node of the mobile terminal; the upper level node of the mobile terminal may configure the register of the accelerometer based on the control instruction, and monitor the amplitude and the range of the gravitational change of the mobile terminal through the register of the accelerometer. In the above-mentioned implementation, the mobile terminal may register using the API and configure the register to adjust the amplitude and the range of the gravitational change required to be detected by the accelerometer. Without increasing manufacture cost, the power consumption may be reduced, and the battery performance may be improved, improving user experience.

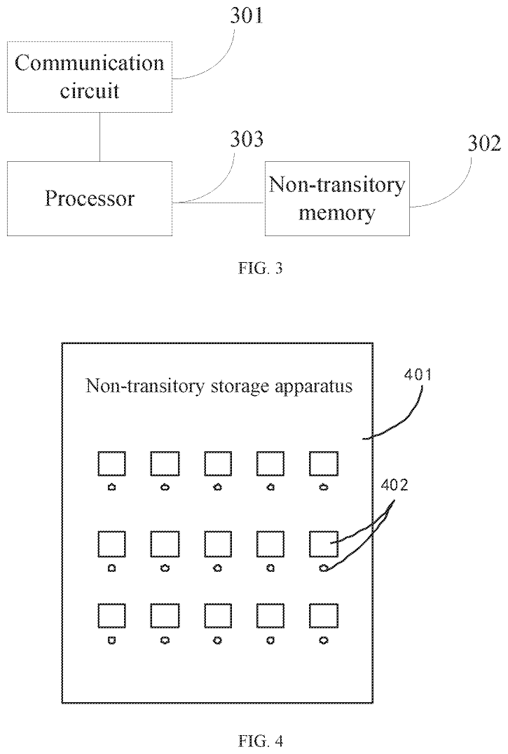

As shown FIG. 3, in the present implementation, the mobile terminal includes a communication circuit 301, a non-transitory memory 302, and a processor 303. The communication circuit 301 may be arranged to transmit the control instruction of the mobile terminal, and the non-transitory memory 302 may be arranged to store data generated during the mobile terminal running.

The processor 303 may be arranged to execute a computer program to perform following operations.

The processor 303 may detect whether the mobile terminal is in the Doze mode. In response to the mobile terminal in the Doze mode, the accelerometer may be activated to sense the particular motion change. In response to the particular motion change reaching the predefined threshold, the processor 303 may deactivate the Doze mode.

In a specific implementation, the processor 303 may activate the Doze mode based on the control instruction and trigger the upper level node of the processor 303. The upper level node of the processor 303 may configure the register of the accelerometer based on the control instruction, and monitor the amplitude and the range of the gravitational change of the mobile terminal through the accelerometer. The upper level node may send the control instruction to the drive layer through the hardware abstraction layer based on the control instruction. The drive layer may acquire the control instruction and configure the register of the accelerometer and activate the interruption function of the accelerometer. In response to the accelerometer of the mobile terminal sensing the gravitational change exceeding the predefined threshold, the system may be activated immediately and the Doze mode may be deactivated, and the accelerometer drive layer may stop sensing the particular motion change.

According to the present implementation, the mobile terminal may generate the control instruction based on the current running state; the mobile terminal may activate the sleep mode based on the control instruction and trigger the upper level node of the mobile terminal; and the upper level node of the mobile terminal may configure the register of the accelerometer based on the control instruction, and monitor the amplitude and the range of the gravitational change of the mobile terminal through the register of the accelerometer. In the above-mentioned implementation, the mobile terminal may register using the API and configure the register to adjust the amplitude and the range of the gravitational change required to be detected by the accelerometer. Without increasing the manufacture cost, the power consumption may be reduced, and the battery performance may be improved, improving user experience.

The present disclosure further provides a computer-readable non-transitory storage medium, as shown in FIG. 4. FIG. 4 is a structural diagram of the computer-readable non-transitory storage medium according to an embodiment of the present disclosure. A non-transitory storage apparatus 401 may store program data 402. The program data 402 may be executed by a processor to perform the above-mentioned method of controlling the mobile terminal. The processor may be a processor arranged in the non-transitory storage apparatus or a processor arranged in other terminal devices. For example, the non-transitory storage apparatus 401 may include any apparatus storing the above-mentioned program data 402, such as at least one of a mobile phone, a tablet computer, and an intelligent watch, and shall not be limited herein.

The program data may perform any method of controlling the Doze mode of the mobile terminal as described in the above-mentioned implementations. A process of the performing the method may refer to FIG. 1 or the above description, and will not be repeatedly described hereafter.

According to the present disclosure, the mobile terminal may configure the register to adjust the amplitude and the range of the gravitational change required to be detected by the accelerometer, replacing the function of the significant motion sensor. Without increasing the manufacture cost, the power consumption may be reduced, and the battery performance may be improved, improving user experience.

The above descriptions illustrate implementations of the present disclosure only, but do not limit the scope of the present disclosure. Any equivalent structural or process transformation based on the specification and the drawings of the present application and directly or indirectly applied to other related art shall be within the scope of the present disclosure.

What is claimed is:

1. A method of controlling a Doze mode of a mobile terminal, comprising:
detecting whether the mobile terminal is in the Doze mode;
in response to the mobile terminal being in the Doze mode, activating an accelerometer to sense a particular motion change; and
in response to the particular motion change reaching a predefined threshold, deactivating the Doze mode.

2. The method according to claim 1, wherein the particular motion change is a gravitational change.

3. The method according to claim 1, wherein the in response to the particular motion change reaching a predefined threshold, deactivating the Doze mode, comprises:
in response to the particular motion change reaching the predefined threshold for a plurality of time consecutively within a predefined period of time, deactivating the Doze mode by the mobile terminal.

4. The method according to claim 2, wherein the in response to the mobile terminal being in the Doze mode, activating an accelerometer to sense a particular motion change, comprises:
in response to the mobile terminal in the Doze mode, configuring a register to adjust the amplitude and a range of the gravitational change required to be detected by the accelerometer, and initiating the accelerometer to sense the particular motion change.

5. The method according to claim 1, wherein, before the detecting whether the mobile terminal is in the Doze mode, the method further comprises:
initiating the accelerometer, and subsequently loading an application for sensing the particular motion.

6. The method according to claim 1, wherein, after the in response to the particular motion change reaching a predefined threshold, deactivating the Doze mode, the method further comprises:
the accelerometer receiving a control instruction of the mobile terminal and stopping sensing the particular motion change.

7. The method according to claim 1, further comprising: in response to the particular motion change not reaching the predefined threshold, the accelerometer continually sensing the particular motion change.

8. The method according to claim 1, wherein the mobile terminal comprises a mobile phone, a tablet computer, and an intelligent watch.

9. A computer-readable non-transitory storage medium, having a computer program stored in, wherein the computer program is capable of being executed by a processor to perform operations of:
detecting, by the processor, whether the mobile terminal in a Doze mode;
in response to the mobile terminal in the Doze mode, initiating an accelerometer to sense a particular motion change; and
in response to the particular motion change reaching a predefined threshold, deactivating the Doze mode by the processor.

10. The computer-readable non-transitory storage medium according to claim 9, wherein the particular motion change is a gravitational change.

11. The computer-readable non-transitory storage medium according to claim 9, wherein the computer program is capable of being executed by the processor to further perform operations of:
deactivating the Doze mode in response to the particular motion change reaching the predefined threshold for a plurality of times consecutively within a predefined period time.

12. The computer-readable non-transitory storage medium according to claim 10, wherein, in response to the mobile terminal in the Doze mode, the computer program is capable of being executed by the processor to further perform operations of:
configuring a register to adjust the amplitude and a range of the gravitational change required to be detected by the accelerometer and activating the accelerometer to sense the particular motion change.

13. The computer-readable non-transitory storage medium according to claim 9, wherein, after the initiating an accelerometer, the computer program is capable of being executed by the processor to further perform operations of:
loading an application for sensing the particular motion.

14. The computer-readable non-transitory storage medium according to claim 9, wherein, in response to the particular motion change not reaching the predefined threshold, the computer program is capable of being executed by the processor to further perform operations of:
instructing the accelerometer to continually sense the particular motion change.

15. A mobile terminal, comprising:
a communication circuit, arranged to transmit a control instruction of the mobile terminal;
a non-transitory memory, arranged to store data generated during the mobile terminal running; and
a processor, arranged to execute a computer program to perform operations of:
detecting, by the processor, whether the mobile terminal in a Doze mode;
in response to the mobile terminal in the Doze mode, initiating an accelerometer to sense a particular motion change; and
in response to the particular motion change reaching a predefined threshold, deactivating the Doze mode by the processor.

16. The mobile terminal according to claim 15, wherein the particular motion change is a gravitational change.

17. The mobile terminal according to claim 15, wherein the processor is further arranged to perform operations of deactivating the Doze mode in response to the particular motion change reaching the predefined threshold for a plurality of times consecutively within a predefined period time.

18. The mobile terminal according to claim 16, wherein, in response to the mobile terminal in the Doze mode, the processor is further arranged to perform operations of configuring a register to adjust the amplitude and a range of the gravitational change required to be detected by the accelerometer and activating the accelerometer to sense the particular motion change.

19. The mobile terminal according to claim 15, wherein, after the initiating an accelerometer, the processor is further arranged to perform operations of loading an application for sensing the particular motion.
